(19) United States
(12) Patent Application Publication
(10) Pub. No.: US 2015/0193166 A1
(43) Pub. Date: Jul. 9, 2015

(54) PORTABLE STORAGE DEVICE WITH POWER BANK

(71) Applicant: Imation Corp., Oakdale, MN (US)

(72) Inventors: Toshihide Hokari, Woodbury, MN (US); Alan Olson, Cottage Grove, MN (US); Blake A. Verdon, St. Paul, MN (US)

(21) Appl. No.: 14/589,133

(22) Filed: Jan. 5, 2015

Related U.S. Application Data
(60) Provisional application No. 61/923,885, filed on Jan. 6, 2014.

(51) Int. Cl. G06F 3/06

(52) U.S. Cl. CPC G06F 3/0625; G06F 3/0679; G06F 3/0655; G06F 2206/1014

(57) ABSTRACT

Aspects of the invention generally relate to a portable storage device including a memory and a rechargeable power source. The portable storage device can include one or more connectors for connecting to one or more remote or external devices, such as a smartphone, table, computer, and the like. The portable storage device can receive digital data for storage in memory from one or more connectors, or can provide access to digital data in its memory to a remote or external device via the one or more connectors. The rechargeable power source can provide electrical power to a device via one or more connectors for recharging a battery of that device, or can receive electrical power from a source via the one or more connectors for recharging the rechargeable power source.

### RELATED APPLICATIONS

The present application claims priority to U.S. provisional application No. 61/923,885, the entire contents of which are incorporated herein by reference.

### BACKGROUND

Remote devices with multiple functionalities are becoming increasingly popular. For example, a smartphone will often serve not only as a user's cellular phone, but also as the user's photo and video camera and music and video player, in addition to an ever-increasing number of other functions. As the functionality of such devices grow, the demand on the battery life and memory storage capacity increases. When a battery dies, a user is forced to find a power source such as a wall receptacle or a computer via which to recharge the battery for further use. In addition, when the memory of the remote device becomes full, a user must unload digital data from the memory so that he or she can continue to utilize the remote device as intended, for example by capturing images or videos. In addition, many remote devices have specific and varying connection ports for interfacing with the device. As such, a user must have the appropriate connector with them in addition to means for recharging the battery and/or receiving digital data from the remote device.

The sharing of digital data between remote devices is also a popular feature. However, because devices are configured differently and require varying connectors for interfacing, sharing typically must be performed by first moving digital data off of one device onto a third device, for example, a computer, and then uploading the digital data to the second device. This is inconvenient as often users do not readily have access to such a third device when desiring to share data. An alternative to requiring the third device for data transfer is to use wireless data transfer, which can be prohibitively or inconveniently slow and/or expensive for a user.

### SUMMARY

Aspects of the present invention provide a portable storage device having a memory and a rechargeable power source. The portable storage device comprises a first connector for connecting to a remote device. The first connector can be a dedicated connector for a particular remote device. In some examples, the memory of portable storage is in two-way communication with the remote device via the first connector, allowing for the transfer of digital data between the two devices. The first connector can also provide electrical power from the rechargeable power source of the portable storage device and the remote device. In some configurations, the first connector can simultaneously provide two-way data transfer between the memory of the portable storage device and the remote device, and electrical power from the portable storage device to the remote device. Thus, a user can connect the remote device to the portable storage device and unload digital data from the memory of the remote device while charging its battery.

The portable storage device can include a second connector for connecting to an external device such as a computer. The second connector can allow two-way data transfer between the memory of the portable storage device and the external device. This allows a user to unload digital data from the memory of the portable storage device, freeing the memory for further use. In addition, the second connector can provide electrical power from the external device to the rechargeable power source, thereby recharging the rechargeable power source for further use.

### BRIEF DESCRIPTION OF THE DRAWINGS

FIG. 1A is a schematic diagram of a portable storage device.

FIG. 1B illustrates an exemplary embodiment of a portable storage device comprising a single connector.

FIG. 2 is a process-flow diagram illustrating exemplary operation of a portable storage device.

### DETAILED DESCRIPTION

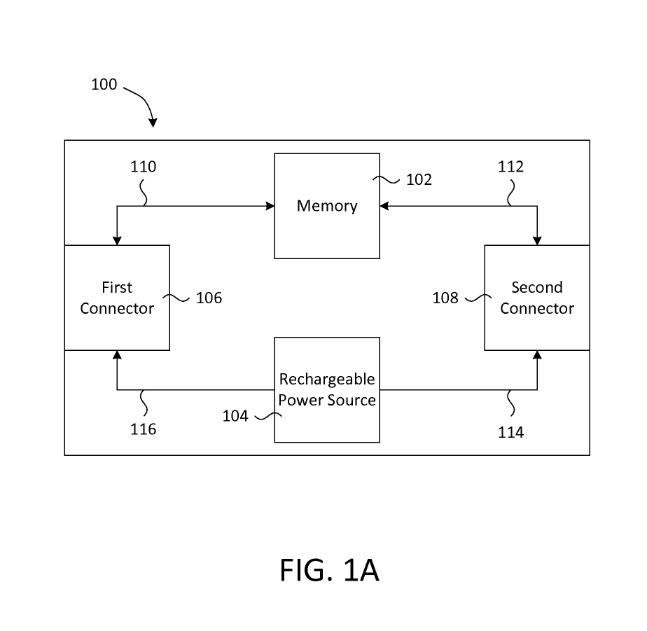

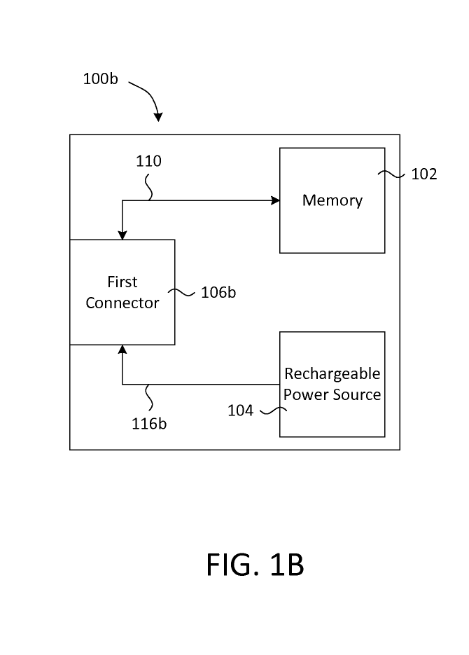

FIG. 1A is a schematic diagram of an exemplary portable storage device according to some embodiments of the invention. Device 100 includes a memory 102, a rechargeable power source 104, a first connector 106 and a second connector 108. In some embodiments, the first connector 106 comprises a particularly configured connector configured to connect with a particular remote device or family of remote devices. In general, a remote device is a device that stands alone from a traditional central or local computer and can be used to acquire and/or display or otherwise present digital data such as photographs, video and audio to a user. Such remote devices can include, for example, cellular telephones, smartphones, tablets, cameras, displays, music players and the like. Exemplary connectors an include USB, micro-USB, mini-USB, HDMI, MHL, Lightning, 30-pin, serial connectors and any other connectors known in the art. In various embodiments, connectors can be specific or proprietary to a remote device. In many cases, remote devices comprise a female port for receiving a connector, and accordingly, in some embodiments, the first connector 106 comprises a corresponding male connector for connecting to the remote device. In general, first connector 106 is configured to conform to a first connector standard, while the second connector 108 is configured to conform to a second connector standard. First and second connector standards can be dependent on the devices with which first 106 and second 108 connectors are intended to interface.

In some embodiments, first 106 and second 108 connectors can be integrated into a housing of the portable storage device 100. In alternative embodiments, one or both of the first 106 and second 108 connectors can be attached to the housing by cable configured to provide communication between the connector(s) and internal components of the portable storage device 100. In some embodiments, such a cable can be integrally coupled to the portable storage device 100, or can alternatively be removable therefrom. In various embodiments, first 106 and second 108 connectors can be the same or different connectors.

First connector 106 can be communication with memory 102 via two-way communication 110. Two-way communication 110 can be used to send data from the remote device to memory 102 or to retrieve data from memory 102 to send to the remote device. Memory 102 can include flash technology, hard drive technology, or other storage technologies known in the art. In some embodiments, flash memory is used to minimize the physical size required for the portable storage device. Accordingly, some portable storage devices include flash memory 102 in sizes of, for example, 16, 32, 64, 128, 256 or 512 GB, or 1 TB. In some embodiments, portable storage device comprises dedicated, built-in memory 102. Device 100 can alternatively or additionally receive or comprise removable memory 102, such as an SD or microSD card. Removable memory 102 can allow the user to provide an appropriate amount of memory for the portable storage device in accordance with the user's desired capacity and cost. To facilitate removable memory 102, the portable storage device 100 can comprise a slot or receptacle for receiving removable memory 102. A user can insert or remove removable memory 102 into or from receptacle. Thus, in some embodiments, the memory 102 of the portable storage device 100 is of a variable size, wherein the user can insert memory 102 of any desirable size and can exchange one sized memory for another.

A remote device can be connected to the portable storage device 100 via the first connector 106 and thereby interface with memory 102 via two-way communication 110 to facilitate the transfer of digital data between the portable storage device 100 and the remote device. In some examples, a user can choose to copy digital data from the remote device to the memory 102 of the portable storage device 100 to back up the data, or to move the data from the remote device to memory 102 to clear space on the remote device. Thus, as used herein, transferring data can refer to moving or copying data from one location to another. In addition, the user can choose to upload digital data from the memory 102 of the portable storage device to the remote device, or to stream digital data from memory 102 to the remote device. Thus, two-way communication 110 allows a user to move data back and forth between a remote device and the memory 102 of the portable storage device by means of the first connector 106.

In some embodiments, the first connector 106 is coupled to the rechargeable power source 104. Rechargeable power source 104 can include known rechargeable elements including lithium ion, lithium polymer, nickel metal hydride, capacitive or other known rechargeable power storage technology. During use, when a user connects a remote device to the first connector 106 of the portable storage device, the rechargeable power source 104 of the portable storage device can provide electrical power to the remote device via the first connector 106. Rechargeable power source 104 can provide power to the remote device via a one-way connection 116. This power can be used to charge the battery of the remote device. In various embodiments, the capacity of the rechargeable power source 104 can range between about 100 and 20,000 mAh. For example, in some such embodiments, the capacity of the rechargeable power source 104 can range between 1,000 and 5,000 mAh. In some embodiments, the capacity of the rechargeable power source 104 is specific to a particular remote device, having the same or similar capacity as the remote device. Thus, in some examples, both the first connector 106 and the rechargeable power source 104 can be specific to a particular remote device for use with the portable storage device.

During an exemplary use, a user operates his or her remote device, such as a smartphone, for acquiring digital data. Data can comprise, for example, music, video, or image data captured by the user using the remote device. With use, the memory of the remote device becomes full and/or the battery becomes depleted of charge. A user can connect the remote device to the portable storage device via the first connector 106 and move digital data from the internal memory of the remote device to the memory 102 of the portable storage device via connection 110 in order to clear space for acquiring more digital data. While the remote device is connected to the portable storage device via the first connector 106, the rechargeable power source 104 of the portable storage device can recharge the battery of the remote device via the first connector 106 and connection 116. In some embodiments, the transfer of data and the charging of the remote device can occur simultaneously. After data has been moved from a first remote device to the memory 102, a user can connect a second remote device to the first connector 106 and transfer the digital data from memory 102 to the second remote device, utilizing the portable storage device to facilitate the transfer of digital data between separate remote devices.

Thus, the user can use the portable storage device 100 to clear space on the remote device while simultaneously recharging the remote device, thereby increasing its operating capacity (e.g., memory space and/or battery life). A user can also connect the remote device to the portable storage device in order to transfer data from the portable storage device to the remote device, or to stream data from the portable storage device for use with the remote device while still charging the remote device. For example, a user can connect a smartphone to the portable storage device and play a video file on the smartphone that is located on memory 102 in portable storage device, while simultaneously charging the smartphone via the rechargeable power source 104.

In some embodiments, when connected, the remote device and portable storage device adopt a ‘master/slave’ or a ‘host/device’ relationship. That is, the remote device (master, host) controls the operation of the portable storage device (slave, device). During operation, a user controls two-way data transfer between the remote device and the portable storage device via the remote device. In some configurations, such as in the case of some smartphones or tablets, for example, the user installs an application (app) or other software on the remote device that allows data transfer control operability. In other embodiments, such operability and/or software is available on the remote device by default. In either case, the user initiates the transfer of data in either direction between the two devices. In some embodiments, the user can control whether or not the remote device is charged by the portable storage device, while in other embodiments, charging occurs automatically.

Through use, the memory 102 in the portable storage device becomes full and/or the rechargeable power source 104 becomes depleted of charge. In some embodiments, the portable storage device comprises a second connector 108 for connecting to an external device. In some embodiments, the second connector 108 comprises a male USB connector, and the external device comprises a computer. The external device can connect to the second connector 108 and provide power to the rechargeable power source 104 via connection 114, or provide two-way communication via connection 112. Thus, the external device can charge the rechargeable power source 104 via the second connection. In addition, the user can initiate two-way data transfer between the portable storage device and the external device, enabling the clearing of memory 102 to provide available storage in the portable storage device. In some embodiments, the interface between the portable storage device and the external device adopts a similar host/device relationship as described above, in which data transfer is controlled via the external device. Additionally, in some embodiments, the charging of the rechargeable power source 104 via the second connector 108 can be initiated by the user via the external device, or can be performed automatically.

In some embodiments, the functionality of the second connector can be integrated into the first connector, allowing for the first connector to connect to a remote device as well as an external device. FIG. 1B illustrates an exemplary embodiment of a portable storage device comprising a single connector. In FIG. 1B, the portable storage device 100b comprises a first connector 106b for interfacing with a remote device as described above, allowing the transfer of digital data to or from a remote device from memory 102, or providing charge to a remote device from rechargeable power source 104. However, in the illustrated embodiment of FIG. 1B, the first connector 106b is in two-way communication with the rechargeable power source 104 via connection 116b so that electrical power can be supplied to the rechargeable power source 104 via the first connector. Accordingly, in such an embodiment, the first connector 106b can be used to connect to an external device to transfer data back and forth between the external device and the memory 102 of the portable storage device 100b, as well as provide electrical power from the external device to the rechargeable power source 104. In some embodiments, the portable storage device 100 includes a connector for connecting directly to a power receptacle such as a wall socket for providing electrical power to the rechargeable power source 104 of the portable storage device 100.

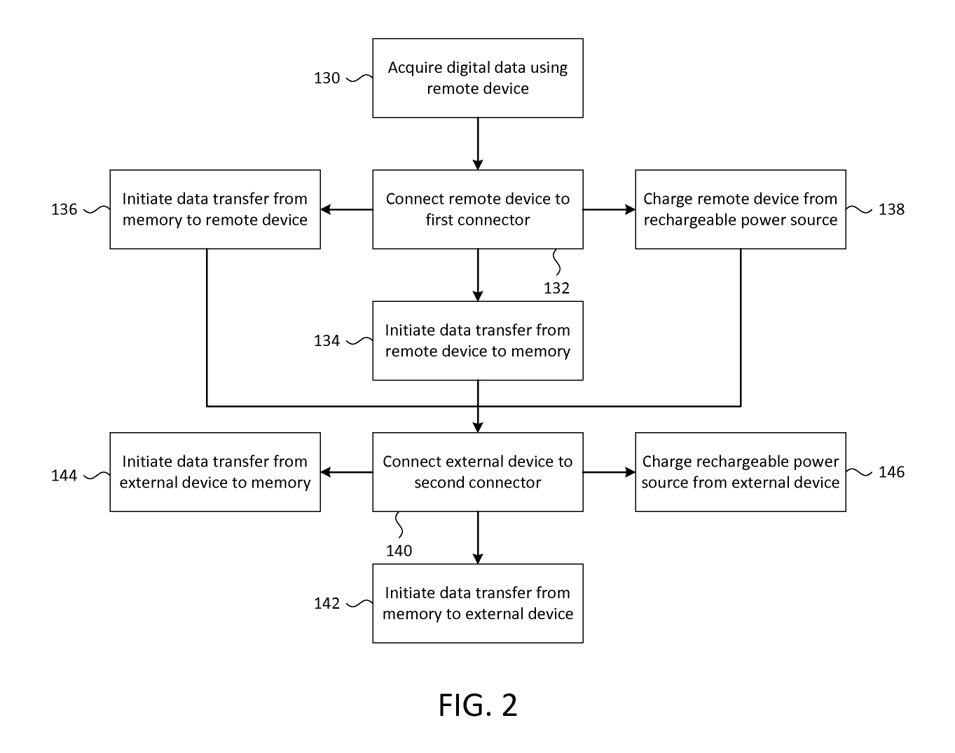

FIG. 2 is a process flow diagram illustrating exemplary operation of a portable storage device in conjunction with a remote device and an external device. A user can begin by using a remote device, such as a smartphone. In some examples, the user can use the remote device to acquire 130 digital data, such as taking pictures or recording video data. Performing such operations drain the batter of the remote device as well as use space in the memory of the remote device. As the remote device memory becomes full and/or the battery becomes depleted, the user can connect 132 the remote device to the portable storage device via the first connector. As discussed elsewhere herein, first connector can comprise one of several different types of connector.

Two-way communication between the remote device and the portable storage device via the first connector allows the user to initiate 134 data transfer from the remote device to the memory of the portable storage device, or to initiate 136 data transfer from the memory of the portable storage device to the remote device. While the two devices are connected, regardless of the status of data transfer, the connection can act to charge 138 the remote device from the rechargeable power source in the portable storage device.

In addition, the user can connect 140 the portable storage device to an external device, such as a computer, via its second connector. In various embodiments, the user can do so while the portable storage device is connected to the remote device via the first connector. Upon connection of the portable storage device with the external device, the user can initiate 142 data transfer from the memory of the portable storage device to the external device to move or copy digital data from the memory in the portable storage device. The user can also initiate 144 data transfer from the external device to the memory of the portable storage media. Similarly, in either case, the connection between these devices via the second connector can act to charge 146 the rechargeable power source in the portable storage device from the external device before, during or after any initiated data transfer. In general, processes outlined in FIG. 2 can be performed with various steps permuted, omitted, or performed simultaneously, depending on the preference or intention of the user and the embodiment of the portable storage device.

Various examples have been described. In some embodiments, the portable storage device can include a plurality of connectors for connecting to various remote devices. The plurality of connectors can include like or different connectors or any combination thereof. A user of any connected remote device can control data flow between the memory in the portable storage device and any attached remote device in a host/device configuration. In some cases, the portable storage device can act as an intermediary between simultaneously connected remote devices, allowing data to be transferred therebetween. Embodiments described herein are exemplary in nature and do not limit the scope of the invention. These and others fall within the scope of the following claims.

1. A portable storage device comprising:
memory;
a rechargeable power source;
a first connector connectable to a remote device and capable of simultaneously providing two-way data transfer between the memory of the portable storage device and a remote device and electrical power from the portable storage device to the remote device; and
a second connector connectable to an external device and capable of providing two-way data transfer between the memory of the portable storage device and an external device and electrical power from the external device to the rechargeable power source of the portable storage device.

2. The portable storage device of claim 1, wherein the memory comprises flash memory.

3. The portable storage device of claim 1, wherein the second connector comprises a male USB connector.

4. The portable storage device of claim 1, wherein the first connector is a dedicated connector for the remote device.

5. The portable storage device of claim 4, wherein the first connector is one of: a USB, micro-USB, mini-USB, HDMI, MHL, Lightning, 30-pin, and serial connector.

6. The portable storage device of claim 1, wherein the memory comprises removable memory.

7. The portable storage device of claim 6, wherein size of the memory is selectable by a user.

8. The portable storage device of claim 1, wherein the memory size is one of: 16, 32, 64, 128, 256 or 512 GB, or 1 TB.

9. The portable storage device of claim 1, wherein the rechargeable power source has a capacity between 1,000 and 5,000 mAh.

10. The portable storage device of claim 1, wherein the remote device is a smartphone or a tablet.

11. The portable storage device of claim 1, wherein the remote device can playback/read information stored on the memory of the portable storage device.

12. The portable storage device of claim 1, wherein the remote device controls the transfer of data between the portable storage device and the remote device.

13. A method comprising:
providing a portable storage device comprising a memory, a power source, and a first connector for interfacing with a mobile device;
coupling the portable storage device to the mobile device via the first connector;
transferring data from the mobile device to the memory of the portable storage device; and
providing electrical power from the power source of the portable storage device to the mobile device.

14. A portable storage device comprising:
memory;
a rechargeable power source; and
a first connector connectable to a remote device and capable of simultaneously providing two-way data transfer between the memory of the portable storage device and a remote device and electrical power from the portable storage device to the remote device, and connectable to an external device and capable of providing two-way data transfer between the memory of the portable storage device and an external device and electrical power from the external device to the rechargeable power source of the portable storage device.
